(19) United States
(12) Patent Application Publication
(10) Pub. No.: US 2016/0251001 A1
(43) Pub. Date: Sep. 1, 2016

(54) VEHICLE LIFT SYSTEM

(71) Applicant: William King, Chatham (CA)

(72) Inventor: William King, Chatham (CA)

(21) Appl. No.: 14/632,662

(22) Filed: Feb. 26, 2015

(51) Int. Cl. B60S 9/02; B60R 25/23

(52) U.S. Cl. CPC B60S 9/02; B60R 25/23

(57) ABSTRACT

A vehicle lift system includes a vehicle including an ignition system to turn the vehicle on or off. A plurality of jack assemblies is attached to the vehicle and each is positionable in an extended position abutting a ground surface and lifting the vehicle off the ground surface or in a stored position is spaced from the ground surface. A cutoff switch is mounted on the vehicle and is engaged by at least one of the plurality of jack assemblies when the jack assemblies are in the stored position and disengaged when the jack assemblies are in the extended position. The ignition system is disabled when the cutoff switch is disengaged and is actuatable when the cutoff switch is engaged.

### BACKGROUND OF THE DISCLOSURE

Field of the Disclosure

The disclosure relates to vehicle mounted jack devices and more particularly pertains to a new vehicle mounted jack device for selectively lifting a vehicle off of a ground surface.

### SUMMARY OF THE DISCLOSURE

An embodiment of the disclosure meets the needs presented above by generally comprising a vehicle including an ignition system to turn the vehicle on or off. A plurality of jack assemblies is attached to the vehicle and each is positionable in an extended position abutting a ground surface and lifting the vehicle off the ground surface or in a stored position is spaced from the ground surface. A cutoff switch is mounted on the vehicle and is engaged by at least one of the plurality of jack assemblies when the jack assemblies are in the stored position and disengaged when the jack assemblies are in the extended position. The ignition system is disabled when the cutoff switch is disengaged and is actuatable when the cutoff switch is engaged.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a side view of a vehicle lift system according to an embodiment of the disclosure.

FIG. 2 is a side view of an embodiment of the disclosure.

FIG. 3 is a bottom view of an embodiment of the disclosure.

FIG. 4 is an end view of an embodiment of the disclosure.

FIG. 5 is an end view of an embodiment of the disclosure.

FIG. 6 is a schematic view of an embodiment of the disclosure.

### DESCRIPTION OF THE PREFERRED EMBODIMENT

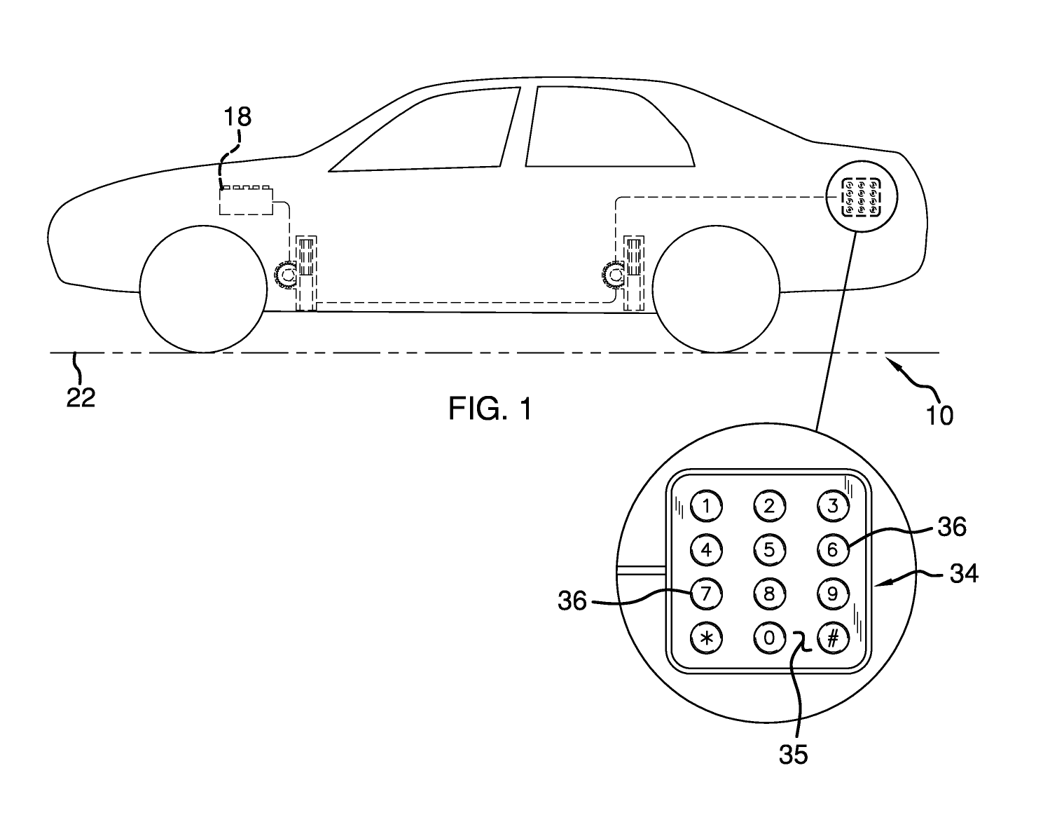

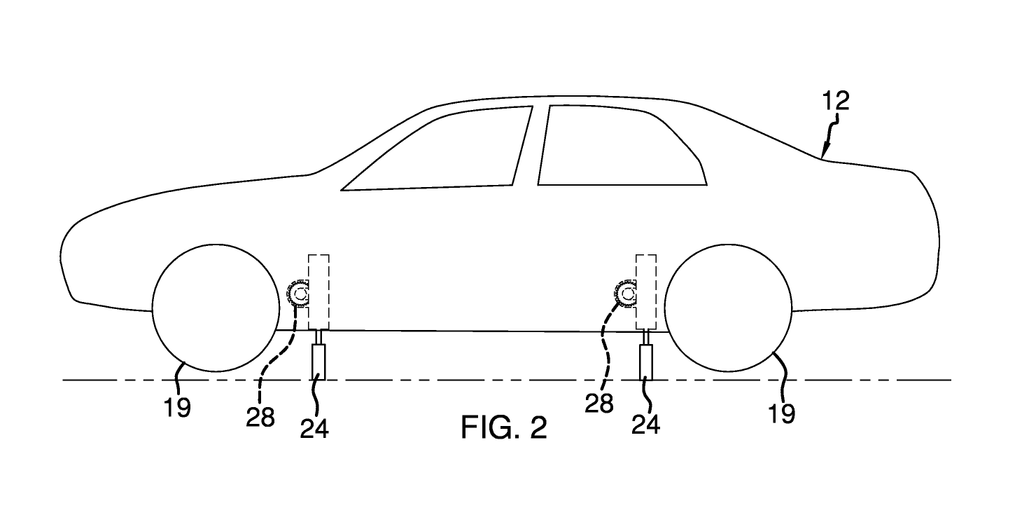

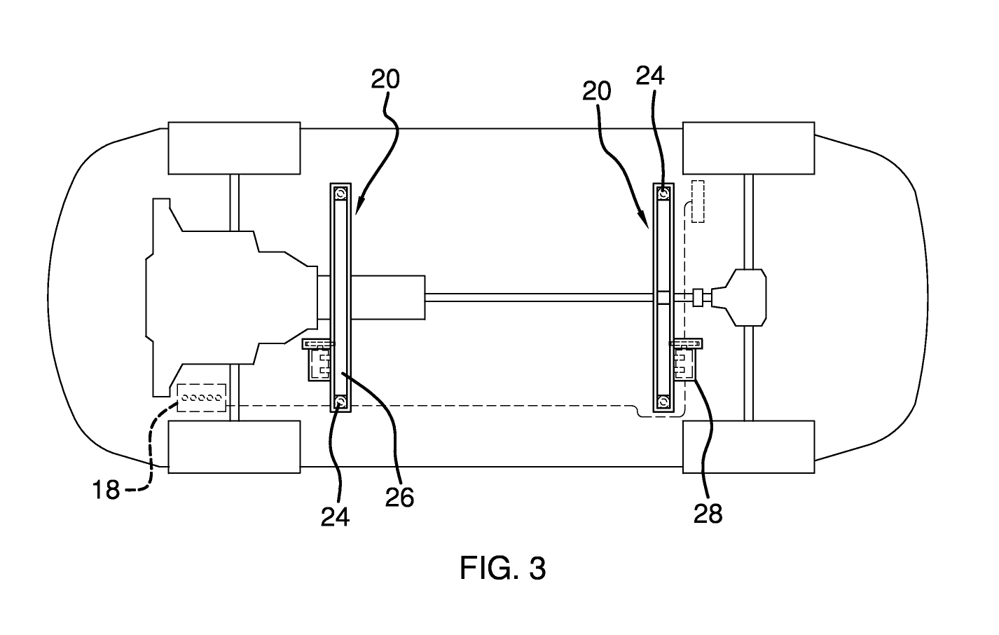

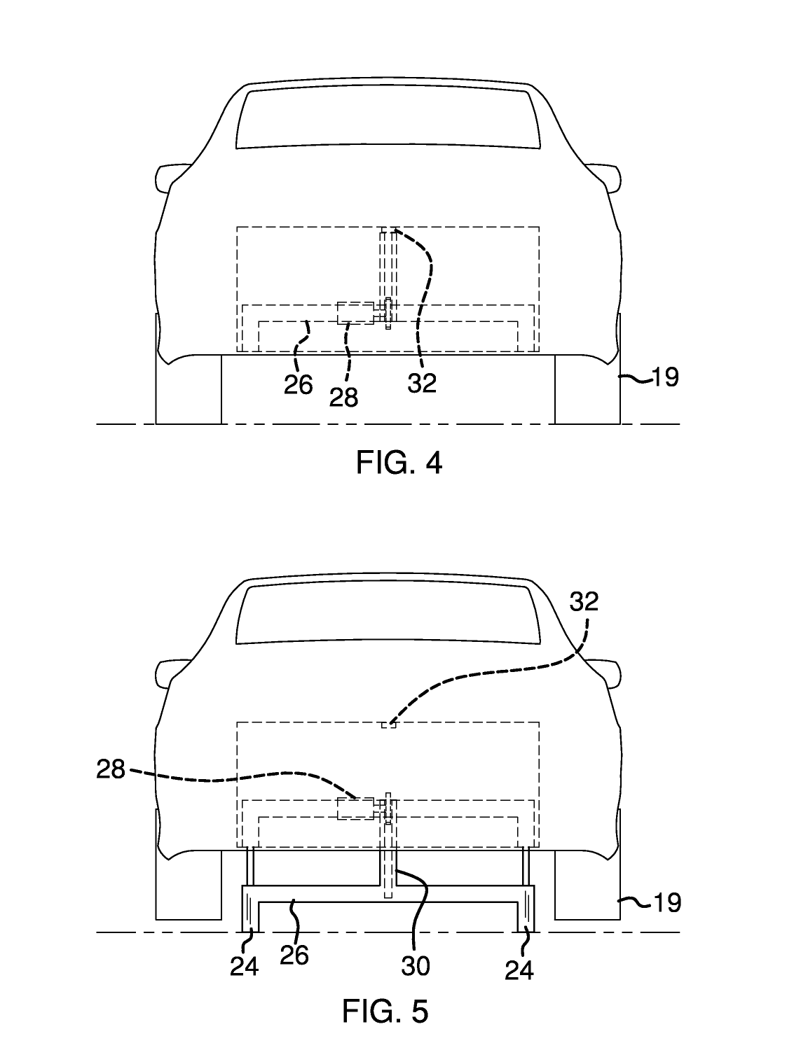

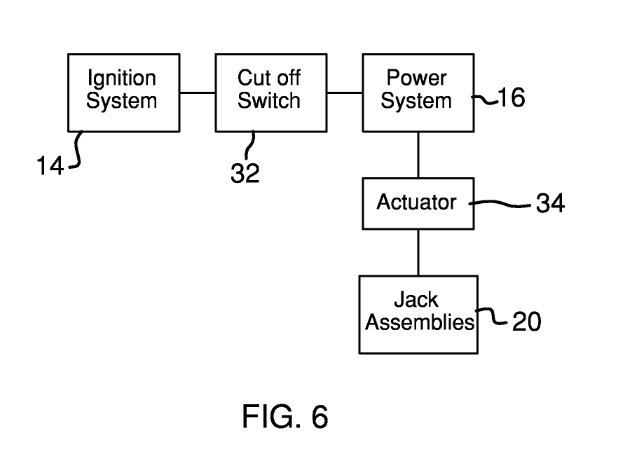

With reference now to the drawings, and in particular to FIGS. 1 through 6 thereof, a new vehicle mounted jack device embodying the principles and concepts of an embodiment of the disclosure and generally designated by the reference numeral 10 will be described.

As best illustrated in FIGS. 1 through 6, the vehicle lift system 10 generally comprises a vehicle 12 that includes an ignition system 14 to turn the vehicle 12 on or off. The vehicle 12 and its ignition system 14 is conventional and may be particularly those vehicles including cars, small trucks, vans and the like. Such vehicles also include a power system 16 that includes a conventional battery 18. The term “vehicle” is inclusive in that the vehicle comprises the body, engine and the like as well as the tires 19 required by the vehicle 12 to be movable.

A plurality of jack assemblies 20 is attached to the vehicle 12. While the exact positioning of the jack assemblies 20 is not critical, it may be preferred that the jack assemblies 20 are secured to a frame of the vehicle 12 and at least one of the jack assemblies 20 may be incorporated into the firewall of the vehicle 12. Each of the jack assemblies 20 is positionable in an extended position abutting a ground surface 22 and lifting the vehicle 12 off the ground surface 22 or positionable in a stored position is spaced from the ground surface 22. Thus when the jack assemblies 20 are in the stored position, the vehicle 12 may freely drive while the vehicle 12 may be worked on, such as for changing tires 19, when the jack assemblies 20 are in the extended position.

The jack assemblies 20 may take any number of conventional forms known in the art. As per the Figures, the jack assemblies 20 may each include a rod 24 that is movable upwardly or downwardly with respect to the vehicle 12. As can be seen in the Figures, the rod 24 may be attached to a base 26 wherein more than one rod 24 is attached to the base 26. A motor 28, and more particularly an electric motor or hydraulic motor, engages the rod 24 and may, in particular, engage the base 26 or an arm 30 attached to the base 26. The motor 28 is electrically coupled to the power system 16 of the vehicle 12. Thus, when the motor 28 moves the base 26 in an upward direction the rods 24 are lifted upwardly as well. When the motor 28 moves the base 26 downwardly the rods 24 engage the ground surface 22 and lift the vehicle 12 and its tires 19 off of the ground surface 22. The Figures show a pair of jack assemblies 20, one nearer a rear of the vehicle 12 and one nearer a front of the vehicle 12, wherein each jack assembly 20 includes a base 26, a motor 28 and a pair of rods 24.

A cutoff switch 32 may be mounted on the vehicle 12. The cutoff switch 32 is engaged by at least one of the plurality of jack assemblies 20 when the jack assemblies 20 are in the stored position and disengaged when the jack assemblies 20 are in the extended position. The ignition system 14 is disabled when the cutoff switch 32 is disengaged and the ignition system 14 is actuatable when the cutoff switch 32 is engaged. This is a safety feature which will prevent the starting or maintaining of the vehicle 12 in an on, or operational, condition when the jack assemblies 20 are extended. This will prevent accidental movement of the vehicle 12 when the jack assemblies 20 are extended. A plurality of cutoff switches 32 may be provided wherein each jack assembly 20 is associated with one of the cutoff switches 32.

An actuator 34 is electrically coupled to the jack assemblies 20. The actuator 34 is actuated to move the jack assemblies 20 between the extended and the stored positions. The actuator 34 is mounted within the vehicle 12 and may include an electronic code input 35. The actuator 34 may include a plurality of keys 36, such as alpha-numeric keys. The actuator 34 is programmed to require a correct order of actuation of the keys 36 to actuate the jack assemblies 20. The actuator 34, in this manner, is a conventional keypad type locking or actuation device which only allows movement of the jack assemblies 20 when a correct code is entered into the electronic code input 35. Further, the actuator 34 may be hidden within the vehicle 12, such as within a trunk of the vehicle 12 and may further be positioned behind a removable door or panel. The hidden nature of the actuator 34 and its requiring a code will prevent both accidental deployment of the jack assemblies 20 and the intentional deployment of such for the purpose of tire 19 theft.

In use, the vehicle 12 is operated in a conventional manner, however the user of the system 10 has the option to lift the vehicle 12 when desired. This may be done for routine maintenance, i.e. oil changes, or for replacement of a flat or overly worn tire 19. The system 10 ensures proper lifting and stability of the vehicle 12 by evenly distributing the rods 24 such that each tire 19 has one rod 24 positioned adjacent thereto. The tires 19 may then be removed and replaced without fear of vehicle 12 instability or the need to properly lift a single tire 19 with a hand jack.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle lift system comprising:
a vehicle, said vehicle including an ignition system to turn said vehicle on or off;
a plurality of jack assemblies being attached to said vehicle, each of said jack assemblies being positionable in an extended position abutting a ground surface and lifting said vehicle off said ground surface, said jack assemblies being positionable in a stored position being spaced from said ground surface; and
a cutoff switch being mounted on said vehicle, said cutoff switch being engaged by at least one of said plurality of jack assemblies when said jack assemblies are in said stored position and disengaged when said jack assemblies are in said extended position, said ignition system being disabled when said cutoff switch is disengaged, said ignition system being actuatable when said cutoff switch is engaged.

2. The vehicle lift system according to claim 1, further including an actuator being electrically coupled to said jack assemblies, said actuator being actuated to move said jack assemblies between said extended and said stored positions, said actuator being mounted within said vehicle, said actuator including an electronic code input.

3. The vehicle lift system according to claim 2, wherein said actuator includes a plurality of keys, said actuator being programmed to require a correct order of actuation of said keys to actuate said jack assemblies.

4. A vehicle lift system comprising:
a vehicle, said vehicle including an ignition system to turn said vehicle on or off;
a plurality of jack assemblies being attached to said vehicle, each of said jack assemblies being positionable in an extended position abutting a ground surface and lifting said vehicle off said ground surface, said jack assemblies being positionable in a stored position being spaced from said ground surface; and
an actuator being electrically coupled to said jack assemblies, said actuator being actuated to move said jack assemblies between said extended and said stored positions, said actuator being mounted within said vehicle, said actuator including an electronic code input.

5. The vehicle lift system according to claim 4, wherein said actuator includes a plurality keys, said actuator being programmed to require a correct order of actuation of said keys to actuate said jack assemblies.

6. A vehicle lift system comprising:
a vehicle, said vehicle including an ignition system to turn said vehicle on or off;
a plurality of jack assemblies being attached to said vehicle, each of said jack assemblies being positionable in an extended position abutting a ground surface and lifting said vehicle off said ground surface, said jack assemblies being positionable in a stored position being spaced from said ground surface, each of said jack assemblies including:
a rod being movable upwardly or downwardly with respect to said vehicle;
a motor being engaged said rod, said motor being electrically coupled to a power system of said vehicle;
a cutoff switch being mounted on said vehicle, said cutoff switch being engaged by said plurality of jack assemblies when said jack assemblies are in said stored position and disengaged when said jack assemblies are in said extended position, said ignition system being disabled when said cutoff switch is disengaged, said ignition system being actuatable when said cutoff switch is engaged; and
an actuator being electrically coupled to said jack assemblies, said actuator being actuated to move said jack assemblies between said extended and said stored positions, said actuator being mounted within said vehicle, said actuator including an electronic code input, said actuator including a plurality of keys, said actuator being programmed to require a correct order of actuation of said keys to actuate said jack assemblies.
